(19) United States
(12) Patent Application Publication
(10) Pub. No.: US 2005/0179854 A1
(43) Pub. Date: Aug. 18, 2005

(54) Drive unit and driving method of liquid crystal panel, and liquid crystal projector using the same

(75) Inventors: Hiroyuki Sekine, Tokyo (JP); Ken Sumiyoshi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/059,396

(22) Filed: Feb. 17, 2005

(30) Foreign Application Priority Data
Feb. 18, 2004 (JP) 2004-041449

(51) Int. Cl. G02F 1/1333

(52) U.S. Cl. 349/161; 345/87

(57) ABSTRACT

In a three-plate-type liquid crystal projector, there may be differences in the temperatures generated in each of three liquid crystal panels since the energy of light irradiated to the liquid crystal panels varies by each color. Due to the differences in the temperatures, there generates differences in the response speeds of liquid crystal molecules, which causes contours to be seen with blur tails when a moving picture is displayed. This can be overcome by the present invention in which correction amount performed on video signals supplied to three liquid crystal panels is changed by each of the three liquid crystal panels according to temperatures, when it is determined that a detected temperature has reached a prescribed value through detecting the temperature of at least one of the three liquid crystal panels, or the peripheral temperature of at least one of the three liquid crystal panels, or the temperature of a prescribed part of a liquid crystal projector.

### BACKGROUND OF THE INVENTION

1. Field of the Invention

The present invention relates to a drive unit and a driving method of a liquid crystal panel used in a liquid crystal display device such as a liquid crystal projector or the like.

2. Description of the Related Art

In a three-plate-type liquid crystal projector, light rays being separated into three primary colors of R, G, B are respectively irradiated onto three liquid crystal panels for single-color display (R (red), G (green), B (blue)) for displaying an image on each liquid crystal panel. The transmitted light is directed into a prism for synthesizing the images in three primary colors of R, G, B by the prism so as to obtain a color picture, and the color picture is projected onto a screen. It is possible with this type of projector to achieve a bright display in high contrast.

Further, in accordance with a recent advance in a micronization technology in manufacturing process and a demand for miniaturization and high-precision thereof, the liquid crystal panel used for the three-plate-type liquid crystal projector has come to have the resolution of 1024 pixels in lateral direction and 768 pixels in longitudinal direction or more in a display area smaller within a diagonal of 1 inch.

FIG. 1 is a block diagram for describing the principle of a three-plate-type liquid crystal projector. Description will be provided hereinafter by referring to the drawing.

A liquid crystal projector 70 comprises a light-source lamp 71, two color separating mirrors 72, 73, three mirrors 74-76, single-color liquid crystal panels 77R, 77G, 77B for R, G, B, a synthesizing prism 78, a projection lens 79 and the like.

The light emitted from the light-source lamp 71 is divided into three primary colors of R, G, B by the two color separating mirrors 72, 73. The separated light in G-color is reflected by the mirror 73 (after transmitting through an incident-side polarization plate (not shown)) to make an incidence to the G-color liquid crystal panel 77G. The separated light in B-color is reflected by the mirrors 74, 75 (after transmitting through an incident-side polarization plate (not shown)) to make an incidence to the B-color liquid crystal panel 77B. The separated light in R-color is reflected by the mirror 76 (after transmitting through an incident-side polarization plate (not shown)) to make an incidence to the R-color liquid crystal panel 77R. The light transmitted through the liquid crystal panels 77R, 77G, 77B makes incidence to the synthesizing prism 78 after transmitting through the emission-side polarization plate (not shown), and the images in R, G, B colors are synthesized by the prism 78 thereby forming a color picture to be enlarge-displayed on a screen (not shown) through the projection lens 79.

Used for the liquid crystal panels 77R, 77G, 77B are liquid crystal panels to which a drive unit manufactured by a poly-Si TFT (poly-silicon thin film transistor) is being unified. The first reason for this is that poly-Si TFT can obtain a larger ON-current compared to a-Si TFT so that TFT forming the pixels can be miniaturized. The second reason is that it enables to dramatically reduce the size of the liquid crystal projector by forming a part of a circuit for driving the liquid crystal panel using the poly-Si TFT.

FIG. 2 is a block diagram of the liquid crystal panel used in the liquid crystal projector. FIG. 3 is a graph showing an example of the relation between the applied voltage and the liquid crystal capacitance in the liquid crystal panel. Description will be provided hereinafter by referring to the drawings.

A liquid crystal panel 80 shown in FIG. 2 is most generally used among the liquid crystal projector, having a drive unit of analog input system being built in. The liquid crystal panel 80 comprises a pixel matrix 81 in which pixels 90 are disposed in matrix at each intersection points of data lines D1-Dn and gate line G1-Gm being arranged crosswise, a data driver circuit 82 for driving the data lines D1-Dn, and a gate driver circuit 83 for driving the gate lines G1-Gm. The pixel 90 is made of a pixel TFT 91, a pixel capacitance Clc and storage capacitance Cst. The data driver circuit 82 samples a plurality of analog video signals S1-S6 supplied from outside to the data lines simultaneously at a prescribed radio frequency.

Next, the action of the liquid crystal panel 80 will be briefly described. First, a single gate line Gy is selected by the gate driver circuit 83 and, at the same time, the analog video signals are written to all the data lines D1-Dn from the data driver circuit 82. Then, when the selected gate line Gy becomes to be in an inactive state, the analog video signals written to the data lines D1-Dn are sampled to each pixel 90 through the pixel TFT 91. Thereby, an image for one line is written to the liquid crystal panel 80. By performing this action for all the gate lines G1-Gm, the image for the whole screen can be written.

In order to obtain a bright projected picture in this type of the liquid crystal projector, it is necessary to irradiate extremely strong light onto a small liquid crystal panel. Thus, the liquid crystal panel generates heat due to the irradiation of the light, thereby causing drawbacks as will be described in the followings.

One of the drawbacks is the phase transition of the liquid crystal caused by an increase in the temperature of the liquid crystal panel. Most of the liquid crystal panels used in the three-plate-type liquid crystal projector are transmission-type TN liquid crystals and N-I transition point (transition point of the nematic phase-isotropic phase) of nematic liquid crystals used therein is at about 100° C. If the liquid crystals transit to the isotropic phase, it becomes impossible to perform display at all. Also, at a high temperature even though it is lower than the transition point, the refractive index anisotropy which determines the optical property drastically changes. Thereby, reduction of the transmittivity and deterioration of the contrast are caused.

Another drawback is the temperature dependency of the response speed of the liquid crystal. The response speed of the liquid crystal is determined according to the drive voltage and elastic constant, viscosity, etc. of the liquid crystal material. Qualitatively, the higher the temperature is, the faster the response becomes, and the lower the temperature is, the slower the response becomes. An issue here is a difference generated in the temperature increase due to the irradiation of the light in a liquid crystal display device for the three primary colors of R, G, B. The temperature increase due to the irradiation of the light depends on the energy of the light to be irradiated. For example, when measuring the light energies irradiated onto the liquid crystal panel in a liquid crystal projector with projected illuminance of about 2000 lm, the values of each color R, G, B were about 1300 mW/cm², 2000 mW/cm², 1800 mW/cm², respectively. Accordingly, the temperatures of the liquid crystal panels for G-light and B-light are high and respond at a high speed while the temperature of the liquid crystal panel for R-light is the lowest and the respond speed becomes slow. As a result, when displaying a moving picture with a fast movement on the liquid crystal projector, there causes such phenomenon of blur tails in different colors generated in the counters due to ununiform response speeds of the liquid crystal panels for each color.

Japanese Patent Unexamined Publication No. 10-39414 discloses a technique for avoiding such drawbacks. In this technique, a cool air is supplied to the liquid crystal panels of R, G, B by a cooling fan to make the generated temperatures of the B, G, R liquid crystal panels uniform. Thereby, differences in the response speeds of each liquid crystal panel are reduced so that the deterioration in the picture quality can be prevented.

Meanwhile, as a technique for improving the response speed of the liquid crystal panel 80, there is an overdrive correction. The overdrive correction is a correction method which controls the response speed of the liquid crystal molecules used in the liquid crystal panel 80 by applying correction to the signal voltage values. The principle thereof will be briefly described.

When displaying a picture on the pixel 90 shown in FIG. 2, the video signal supplied to the data line Dx is stored, that is, written to the liquid crystal capacitance Clc and the storage capacitance Cst through the pixel TFT 91. The time spent for writing the signal in the liquid crystal panel of XGA (1024×768 pixels) is short, which is about 1/1000 of a frame period for displaying one frame of the screen. As for the writing time, the response speed of the TN liquid crystal which is generally used in the transmission-type liquid crystal panel is about the same as the frame period or longer. Therefore, when the display in the pixel 90 is switched, the orientation state of the liquid crystal molecules is to be changed after new video signal voltage is written to the pixel 90 and the pixel TFT 91 is switched to be in the holding action.

The liquid crystal capacitance Clc at the time of stationarily applying an arbitrary voltage V in the state where the change in the orientation of the liquid crystal molecules is completed can be expressed as Clc (V) as a function of the applied voltage V. An example of the relation between the applied voltage V and the liquid crystal capacitance Clc is shown in FIG. 3. When the display on the pixel 90 is altered from the state of the voltage V0 to the state of the voltage V1, an electrical charge amount Q held by the liquid crystal capacitance Clc and the storage capacitance Cst using a general driving method can be expressed by a following expression.
Q=V1(Clc(V0)+Cst) (1)

However, an electrical charge amount Q′ which is practically required when the pixel 90 is stabilized in the orientation state corresponding to the target voltage V1 can be expressed by a following expression. Thus, the voltage fluctuation by the difference between Q and Q′ is to limit the response speed of the liquid crystal molecules.
Q′=V1(Clc(V1)+Cst) (2)

The overdrive correction is a driving method in which a correction is applied to the applied voltage V so as to compensate the difference. As an example, a calculation method of a correction voltage V1′ when changing the pixel 90 form the initial state V0 to V1 is expresses by a following expression.
V1′=(Clc(V1)+Cst)/(Clc(V0)+Cst)×V1 (3)

According to the expression (3) and FIG. 3, for example, V1′>V1 when V1>V0. On the contrary, V1′<V1 when V1<V0. Arithmetic operation using the expression (3) can be achieved through calculating or measuring the voltage dependency of the liquid crystal capacitance in advance and then forming the table. Specifically, it can be achieved by forming LUT (lookup table) in which the video signal V0 displayed previously and the video signal V1 to be displayed next are used as input values and the video signal after correction is used as an output value. Other than this, the arithmetic operation expressed by the expression (3) may be performed by means of hardware or software.

The example shown herein is a method in which the voltage fluctuation in accordance with the change in the liquid crystal capacitance is corrected. There are other techniques being proposed, in which the response speed is more improved by writing the voltage having a larger change amount than the target voltage onto the liquid crystal pixel when there is a change generated on the display. In general, the former technique is effective when the response speed of the liquid crystal molecule is about one frame period or less while the latter technique is effective when the response speed is one frame period or more.

Further, Japanese Patent Unexamined Publication No. 2002-108294 discloses a technique for making the response speed uniform through the correction by the overdrive. In this technique, the response speed of the liquid crystal display device is made uniform by switching ROM of a lookup table in which the correction amounts performed to video signal is recorded, when frame rate of the video signal supplied to the liquid crystal display device changes. In Japanese Patent Unexamined Publication No. 2002-108294, the peripheral temperatures of the liquid crystal display device are detected and the frame rate is converted according to the temperatures. As a result, the response speed is made uniform.

However, in the technique disclosed in Japanese Patent Unexamined Publication No. 10-39414, it is difficult to design a cooling device of the projector device itself. In other words, the cycle for developing projectors is as short as one year and the performances of the liquid crystal display devices, the light-source lamps and the like are improved during the cycle. Thus, it is necessary for each time to redesign in consideration of increase in the temperatures of the liquid crystal panels, which causes extension of the term for development and increase in the cost for development.

Further, in the case where a change in the response speed of the liquid crystal display device due to the temperature change is adjusted by converting the frame rate of the signal to be supplied to the liquid crystal display device as in the technique disclosed in Japanese Patent Unexamined Publication No. 2002-108294, the same response-speed correction is applied to the signals in all the colors of R, G, B. Therefore, there is a difference generated in the response speed of each liquid crystal panel in a three-plate-type liquid crystal display device which uses three liquid crystal display devices for the three primary colors.

### SUMMARY OF THE INVENTION

An object of the present invention is to improve the picture quality at the time of displaying a moving picture by making the response speeds of each liquid crystal panel uniform even in the case where there is a difference generated in the temperatures of each liquid crystal panel caused by irradiation of light with different energies onto three liquid crystal panels for each color of R, G, B being used in a three-plate-type liquid crystal projector.

In order to achieve the foregoing object, the drive unit of the present invention is a drive unit of a liquid crystal panel used in a liquid crystal display device in which an image based on a single-color video signal is displayed on a respective liquid crystal panel and the images displayed on a plurality of the liquid crystal panels are synthesized into a picture for display. The drive unit comprises a temperature detection device and a correction device. The temperature detection device directly or indirectly detects the temperatures of the liquid crystal panels by each panel. The correction device determines the corrected video signal to be displayed in a present frame by each liquid crystal panel according to at least three variables which are a correction amount control value determined according to the temperature of the liquid crystal panel detected by the temperature detection device, the video signal displayed in the previous frame, and the video signal to be displayed in the present frame.

In order to achieve the adequate white balance, consequently, it is necessary to irradiate the light of different energies to a plurality of the liquid crystal panels respectively. Therefore, there is a difference generated in the temperatures of the liquid crystal panels, which causes generation of a difference in the response speeds. Thus, by detecting the temperature of each liquid crystal panel and using the data on the temperatures, the overdrive correction is applied on the video signal by each liquid crystal panel. Thereby, the response speeds of each of the liquid crystal panel are made uniform so that the picture quality at the time of displaying a moving picture can be improved.

It is desirable that, in the above-described drive unit, the video signal for one frame is held in the memory and the correction device comprises lookup tables in the number corresponding to the correction amount control values which can be taken. In the lookup table, the present frame video signal after being corrected is recorded in a position which is determined by two address values, one of which is the digitized video signal of the previous frame held in the memory and the other is the digitized video signal of the present frame.

For example, when the correction amount control values are expressed by integers of 1 to 100, the number of the correction amount control values which can be taken is a hundred. At this time, the correction device comprises a hundred lookup tables by corresponding to the correction amount control values. In the lookup table, for example, the vertical axis is the previous frame video signal and the horizontal axis is the present frame video signal. Therefore, upon inputting the three variables, it is possible to instantly determine the corrected video signal to be displayed in the present frame using the lookup table.

The above-described correction device may be in the configuration which comprises the lookup tables in which the corrected present frame video signal is recorded in a position which is determined by two address values, one of which is the digitized video signal of the previous frame held in the memory and the other is the digitized video signal of the present frame, and the corrected present frame video frame obtained by the lookup table is further corrected according to the correction amount control value.

A correction device comprises a single lookup table in which, for example, the vertical axis is the previous frame video signal and the horizontal axis is the present frame video signal. Thus, by inputting the two variables, it is possible to obtain the corrected video signal (initial value) of the present frame using the lookup table. Subsequently, by applying the initial value and the correction amount control value into the arithmetic expression, the corrected video signal (final value) to be displayed in the present frame can be determined. In the present invention, only the small memory capacitance is required for the lookup table.

The above-described drive unit may further comprise a plural-writing device for writing the video signal for one screen to the liquid crystal panel for a plurality of times within one frame period by which the video signal for one screen is supplied from the signal source. The plural-writing device writes the corrected video signal of the present frame determined by the correction device at least once out of a plurality of the times.

For example, when the writing is performed twice, the present frame video signal after being corrected is written in the first writing and the present frame video signal before being corrected is written in the second writing. In the present invention, the number of supplying the electric charge to the liquid crystal pixel performed within a unit time is increased. Therefore, the voltage fluctuation in accordance with the changes in the arrangement of the liquid crystal molecules can be more decreased and effect of improving the response speed can be increased.

The correction device uses the number of writing performed by the writing device as a fourth variable and determines the corrected video signal to be displayed in the present frame according to on the variables.

That is, the corrected video signal to be displayed in the present frame is changed according to the number (first, second - - - ) of writing which is being performed. For example, when the number of the writing which performed is the second-time writing, the present frame video signal which is corrected to be larger than the regular signal is written in the first time and the present frame video signal which is corrected to be smaller than the regular signal is written in the second time. At this time, the voltage fluctuation of the liquid crystal pixel is more increased in the first time and it is converged in the second time. Thereby, the response speed can be more increased since the larger the voltage is, the faster the response speed of the liquid crystal molecule becomes.

The above-described temperature detection device may be in the configuration which detects the temperature of at least a single liquid crystal panel, and the correction device may be in the configuration which determines the corrected video signal to be displayed in the present frame at least for the single liquid crystal panel. As described, it is not always necessary to detect the temperatures and correct the video signals for all the liquid crystal panels. Further, a plurality of liquid crystal panels may be formed by three panels for displaying each picture in red, green, and blue, and the liquid crystal display device may be a liquid crystal projector.

The liquid crystal projector according to the present invention comprises: the drive unit of the present invention; three liquid crystal panels for displaying each image in red, green and blue by being driven by the drive unit; and an optical system which synthesizes the images displayed in the liquid crystal panels for projecting it to the screen as a single picture.

The liquid crystal projector may be a front type or a rear type.

Further, in the present invention, when the single-color images displayed in the liquid crystal panel are in R, G, B colors, the liquid crystal display device may be in the configuration as described in the followings.

That is, the liquid crystal display device of the present invention is the liquid crystal display device having three liquid crystal panels for R-light, B-light, and G-light, which is built in the configuration which comprises: a device for detecting the temperature of at least one of the three liquid crystal panels, or the temperature of the periphery of at least one of the three liquid crystal panels, or the temperature of a prescribed part of the liquid crystal display device; and a correction device for changing the correction amount applied to the video signals to be supplied to the three liquid crystal panels according to the detected temperature by each liquid crystal panel.

The liquid crystal display device of the present invention may be the three liquid crystal panels for R-light, B-light, and G-light, which is built in the configuration which comprises: a device for detecting the temperature of at least one of the three liquid crystal panels, or the temperature of the periphery of at least one of the three liquid crystal panels, or the temperature of a prescribed part of the liquid crystal display device; and a correction device for changing the correction amount applied to the video signal to be supplied to the liquid crystal panel for R-light according to the detected temperature.

The above-described correction device may be in the configuration in which the corrected signal to be displayed in the present frame is determined according to the three variables which are the video signal displayed in the previous frame, the video signal to be displayed in the present frame, and the correction amount control value.

Further, the liquid crystal display device of the present invention may be in the configuration which comprises: a memory for holding at least the video signal for one frame in the three primary colors of R, G, B; and a correction device having lookup tables in the number which corresponds to the number of resolutions of a correction amount control signal, and the lookup table has the corrected video signal of a present frame being recorded in a position which is determined according to two address values, one of which is a digitized video signal of a previous frame held by the memory and the other is a digitized video signal of the present frame.

Further, it may be the configuration in which the memory writes the video signal for one screen twice or more on the liquid crystal panel within a frame period by which the video signal for one screen is supplied to the liquid crystal display device from outside.

Further, the liquid crystal display device of the present invention may be in the configuration which comprises: a writing device for writing a video signal for one screen twice or more on the liquid crystal screen within a frame period by which a video signal for one screen is supplied to the liquid crystal display device from outside; and a correction processing device for performing correction processing by changing a correction amount of the correction processing applied to the video signal to be written to the liquid crystal panel in the first time and that of the correction processing applied to the video signal to be written thereafter.

In order to drive the liquid crystal display device of the present invention, the temperature of at least one of the three liquid crystal panels for R-light, B-light, and G-light, or the temperature of the periphery of at least one of the three liquid crystal panels, or the temperature of a prescribed part of the liquid crystal display device is detected and the correction amount applied to the video signal to be supplied to the three liquid crystal panels is changed according to the detected temperatures by each liquid crystal panel.

In order to drive the liquid crystal display device of the present invention, the temperature of at least one of the three liquid crystal panels, or the temperature of the periphery of at least one of the three liquid crystal panels, or the temperature of a prescribed part of the liquid crystal display device is detected and the correction amount applied to the video signal to be supplied to the liquid crystal panel for R-light is changed according to the detected temperature.

As a method for applying correction to the video signals, the corrected signal to be displayed in the present frame may be determined according to the three variables which are the video signal displayed in the previous frame, the video signal to be displayed in the present frame, and the correction amount control value.

Further, the liquid crystal display device of the present invention may be in the configuration which comprises a lookup table having the corrected video signal of a present frame being recorded in a position which is determined according to two address values, one of which is a digitized video signal of a previous frame and the other is a digitized video signal of the present frame held by a memory for holding at least the video signal for one frame of three primary colors of R, G, B. The lookup tables may be provided in the number which corresponds to the number of resolutions of the correction amount control value, and a plurality of the lookup tables used for correction may be switched when changing the correction amount.

The video signal for one screen may be written twice or more on the liquid crystal panel within a frame period by which the video signal for one screen is supplied to the liquid crystal display device from outside.

The action of writing a signal for one screen on the liquid crystal panel may be performed twice or more within a frame period by which a video signal for one screen is supplied to the liquid crystal display device from outside, and the correction processing may be performed by changing a correction amount of the correction processing applied to the video signal to be written to the liquid crystal panel in the first time and that of the correction processing applied to the video signal to be written thereafter.

In the present invention, the temperatures are detected by each liquid crystal panel and the corrected video signal to be displayed in the present frame is determined for each liquid crystal panel based on the correction amount control value determined according to the detected temperature, the video signal displayed in the previous frame, and the video signal to be displayed in the present frame. Thus, even though there is a difference in the temperatures being generated between with the liquid crystal panels, the response speed of each liquid crystal panel can be made uniform. Thereby, the picture quality at the time of displaying a moving picture and the like can be improved.

Further, it enables to prevent the so-called “picture with a blur tail” generated at the time of displaying a moving picture caused by ununiform response-speed of the three liquid crystal panels. The reason for this is that even when a cooling system can't compensate the different temperatures and the temperatures of each of the liquid crystal panels become different due to irradiation of the different light energies applied to each of the liquid crystal panels of R, G, B, it is possible to estimate the response speed of each liquid crystal panel by detecting the temperatures of the panels and to apply the different amount of correction to the video signals supplied to each of the liquid crystal panels of R, G, B so as to compensate the difference in the response speeds for making them uniform.

Another effect is that it enables to keep the low cost for developing the liquid crystal projector. The reason is as follows. In the present invention, the response speeds are made uniform by measuring the changes in the temperatures of the three liquid crystal panels within the liquid crystal projector and controlling the signal correction amount based on the data, so that it is unnecessary to make the temperatures of the three liquid crystal panels strictly uniform at the time of designing a cooling system of the liquid crystal projector. Thereby, it is possible to simplify the design of the cooling system, so that the cost for development can be kept low as a result.

Still another effect is that it enables to achieve miniaturization of the liquid crystal projector. The reason for this is that, with the present invention, it is possible to simplify the cooling system since it is unnecessary to make the temperatures of the three liquid crystal panels strictly uniform and, as a result, a casing of the liquid crystal projector can be miniaturized.

### BRIEF DESCRIPTION OF THE DRAWINGS

FIG. 1 is a block diagram for showing a conventional liquid crystal projector;

FIG. 2 is a block diagram for showing a liquid crystal panel used in a liquid crystal projector;

FIG. 3 is a graph showing an example of the relation between the applied voltage and the liquid crystal amount in the liquid crystal panel;

FIG. 4 is a block diagram showing a first embodiment of a drive unit according to the present invention;

FIG. 5 is a block diagram for showing a correction operation unit shown in FIG. 4;

FIG. 6 is a block diagram showing a second embodiment of a drive unit according to the present invention;

FIG. 7 is a block diagram for showing an operation unit shown in FIG. 6;

FIG. 8 is a block diagram showing a third embodiment of a drive unit according to the present invention;

FIG. 9 is a block diagram for showing an example of the liquid crystal projector used in the drive unit shown in FIG. 4;

FIG. 10 is a block diagram showing a first example of an overdrive correction circuit shown in FIG. 5;

FIG. 11 is a block diagram showing a second example of the overdrive correction circuit shown in FIG. 5; and

FIGS. 12 are flowcharts showing the action of the drive unit of FIG. 8, in which FIG. 12A shows a first example and FIG. 12B shows a second example.

### DESCRIPTION OF THE PREFERRED EMBODIMENTS

Now, embodiments of the drive unit according to the present invention will be described in detail by referring to accompanying drawings.

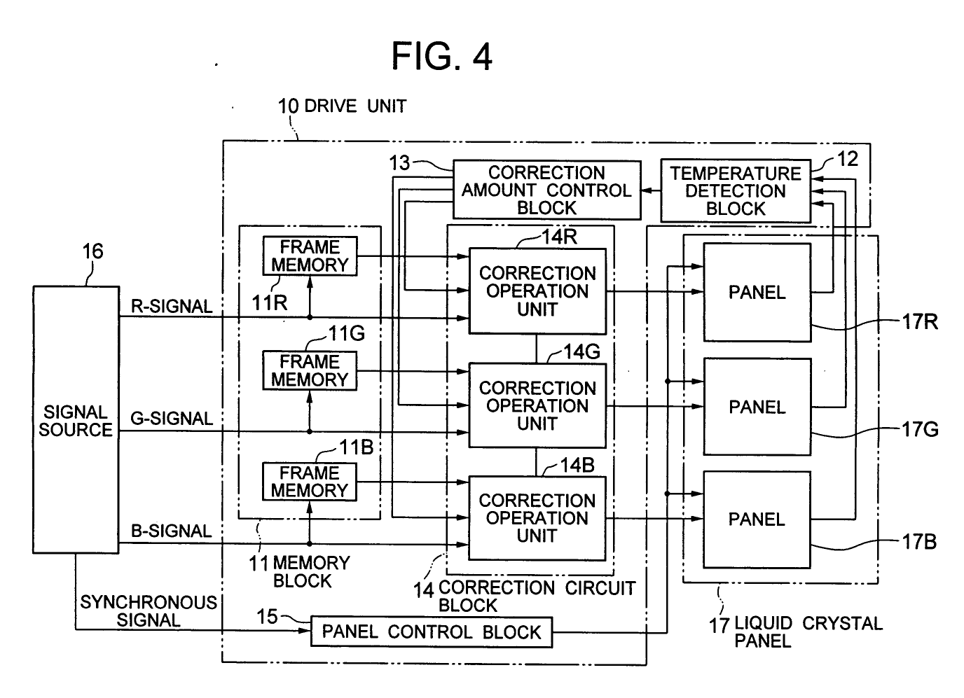

FIG. 4 is a block diagram showing a first embodiment of the drive unit according to the present invention. Description will be provided hereinafter by referring to the drawing.

A drive unit 10 of the embodiment is an electronic circuit used in a three-plate-type liquid crystal projector, which comprises a memory block 11, a temperature detection block 12, a correction amount control block 13, a correction circuit block 14, a panel control block 15, and the like.

The memory block 11 includes frame memories 11R, 11G, 11B for R, G, B for holding video signals in each color of R, G, B supplied from a signal source 16 at least for one frame period. A liquid crystal panel 17 includes panels 17R, 17G, 17B for the three primary colors of R, G, B. The temperature detection block 12 detects the temperatures of each of the panels 17R, 17G, 17B or the temperatures of the peripheries, respectively.

The correction amount control block 13 controls the correction amount applied to the video signals. The correction circuit block 14 includes correction operation units 14R, 14G, 14B for three primary colors of R, G, B. The correction operation units 14R, 14G, 14B for three primary colors of R, G, B perform correction operation onto the video signals which are supplied to the corresponding liquid crystal panels 17R, 17G, 17B for three primary colors of R, G, B according to the video signal of the previous frame held in the corresponding frame memories 11R, 11G, 11B, the video signal of the present frame, and an input value (correction amount) from the correction amount control block 13. The panel control block 15 drive-controls the liquid crystal panels of the three primary colors of R, G, B according to the synchronous signals inputted from the signal source 16.

Further, although not shown in the drawing, the drive unit 10 also comprises an ADC (analog-digital-converter) and the like as necessary in addition to comprising a control circuit block for controlling the entire system, a power source block and the like for generating various voltages. In the case where the circuit for performing the correction processing onto the above-described video signals of the three-primary colors of R, G, B is constituted of a digital circuit, the video signals outputted from the signal source 16 are analog signals. Therefore, the above-described ADC becomes necessary for converting the analog signals to the digital signals.

Next, the action of the drive unit 10 will be described. First, the video signal of three primary colors R, G, B supplied form the signal source 16 are supplied to the frame memories 11R, 11G, 11B for the three primary colors R, G, B and to the correction operation units 14R, 14G, 14B for the three primary colors R, G, B. Thus, the video signal in R-color is supplied to the frame memory 11R and also to the correction operation unit 14R. The video signal in G-color is supplied to the frame memory 11G and also to the correction operation unit 14G. The video signal in B-color is supplied to the frame memory 11B and also to the correction operation unit 14B.

The state of the memory block 11 holding the video signals will be described in detail. When displaying an image according to the video signals on the liquid crystal panel, the video signals are transmitted from the signal source 16 one after another by each frame period. Here, among the video signals transmitted from the signal source 16 by a frame unit in sequence (in terms of time), the former video signal is referred to as the video signal of the previous frame and the latter video signal is referred to as the video signal of the present frame. The memory block 11 temporarily holds the video signal when the video signal of the previous frame is inputted from the signal source 16. The memory block 11 reads out the video signal of the previous frame being held and outputs it to the correction circuit block 14 when the next video signal of the present frame is inputted from the signal source 16. Then, the memory block 11 deletes the video signal of the previous frame being held and, instead, temporarily holds the video signal of the present frame which is outputted next from the signal source 16. The memory block 11 continuously performs the above-described action and temporarily holds the video signals of the frames transmitted one after another from the signal source 16.

The temperature detection block 12 regularly (or irregularly) detects the temperatures of the liquid crystal panels 17R, 17G, 17B or the temperatures of the peripheries, and transfers the results to the correction amount control block 13.

The correction amount control block 13 calculates the correction amount (the response-speed correction of the liquid crystal panels) performed on the video signals for each of the liquid crystal panels 17R, 17G, 17B according to the temperature detection signals outputted from the temperature detection block 12 by corresponding to the liquid crystal panels 17R, 17G, 17B, and outputs the calculated correction amount by each of the liquid crystal panels 17R, 17G, 17B to the correction circuit block 14.

The signal source 16 individually outputs a single-color (R, G, B) video signal and also outputs the synchronous signals by synchronizing with the output of the single-color (R, G, B) video signal. The panel control block 15, upon receiving the above-described synchronous signals from the signal source 16, generates control pulses for operating the liquid crystal panels 17 (17R, 17G, 17B) and supplies the pulses to the liquid crystal panels 17 (17R, 17G, 17B).

A device for detecting the temperature is formed by the temperature block 12. Also, a device for correction is formed by the memory block 11, correction amount control block 13, and the correction circuit block 14.

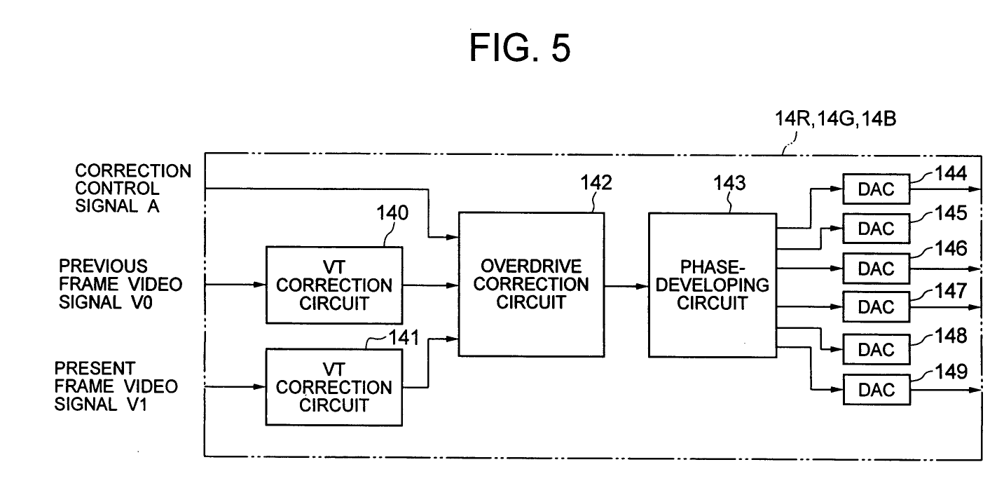

FIG. 5 is a block diagram for showing the correction operation units 14R, 14G, 14B in detail, which are included in the correction circuit block 14 shown in FIG. 4.

As shown in FIG. 5, the correction operation units 14R, 14G, 14B included in the correction circuit block 14 comprise, respectively, a VT correction circuit 140 to which the video signal V0 of the previous frame is inputted, a VT correction circuit 141 to which the video signal V1 of the present frame is inputted, an overdrive correction circuit 142 for performing overdrive correction according to a correction control signal A from the correction amount control block 13 and the VT (voltage-trasmittivity) correction amount from the two VT correction circuits 140, 141, a phase developing circuit 143 for phase-developing the video signal which is overdrive-corrected by the overdrive correction circuit 142, and DACs (digital-analog-converter) 144-149 and the like for converting the video signal (digital signal) which is phase-developed in the phase developing circuit 143 into the analog signal.

In the drawing, as a path of the signal, the VT correction circuits 140, 141, the overdrive correction circuit 142, the phase developing circuit 143, the DACs 144-149 are connected in this order, however, the order as the signal path between the VT correction circuits 140, 141, the overdrive correction circuit 142, and the phase developing circuit 143 may be determined at will. By changing the order, the following effects can be obtained. That is, when the previous frame video signal V0 and the present frame video signal V1 are directly phase-developed, the phase developing circuit 143 is placed in the front row of the VT correction circuits 140, 141. With this configuration, it enables to obtain the effect of reducing the operation speed of the circuit. In the meantime, the phase developing circuit 143 may be placed in the rear row of the DACs 144-147. In this case, the scale of the circuit can be reduced.

Further, in the embodiment, the D-A conversion by the DACs 144-147 is the processing necessary for converting the digital signals to the analog signals which can be inputted to the liquid crystal panel 17 when the VT correction, the overdrive correction and the like are digital-processed. Therefore, it is not required when the processing is all achieved by the analog circuit.

Next, the actions of the correction operation units 14R, 14G, 14B will be described. First, the VT correction circuits 140, 141 respectively perform the VT correction on the corresponding previous frame video signal V0 and the present frame video signal V1, and output the results to the overdrive correction circuit 142. The VT (voltage-transmittivity) correction herein means to correct nonlinearity of the transmitted-light amount for the signal voltage (video signal) outputted to the liquid crystal panel 17. In general, it is achieved by referring to LUT (lookup table) in which the properties are written.

The overdrive correction circuit 142 performs the overdrive correction on each signal of R, G, B by the individual correction amount according to video signals which are VT-corrected by the VT correction circuits 140, 141 and the correction control signal A outputted from the correction amount control block 13. The overdrive correction is the arithmetic operation processing for outputting the corrected video signal V according to the previous frame video signal V0 displayed previously, the present frame video signal V1 to be displayed at this time, and the control signal A for controlling the correction amount.

The phase developing circuit 143 phase-develops the video signals which are overdrive-corrected in the overdrive correction circuit 142 for the number of the analog signals which are to be outputted to the liquid crystal panel 17. The above-described phase development is the processing for parallel-developing the video signals V for the number of analog signals which are to be outputted to the liquid crystal panel 17.

The DACs 144-149 perform D-A (digital-analog) conversion on the video signals (digital signals) V, which are phase-developed by the phase developing circuit 143, and supply the video signals being converted to the analog signals to the liquid crystal panel 17.

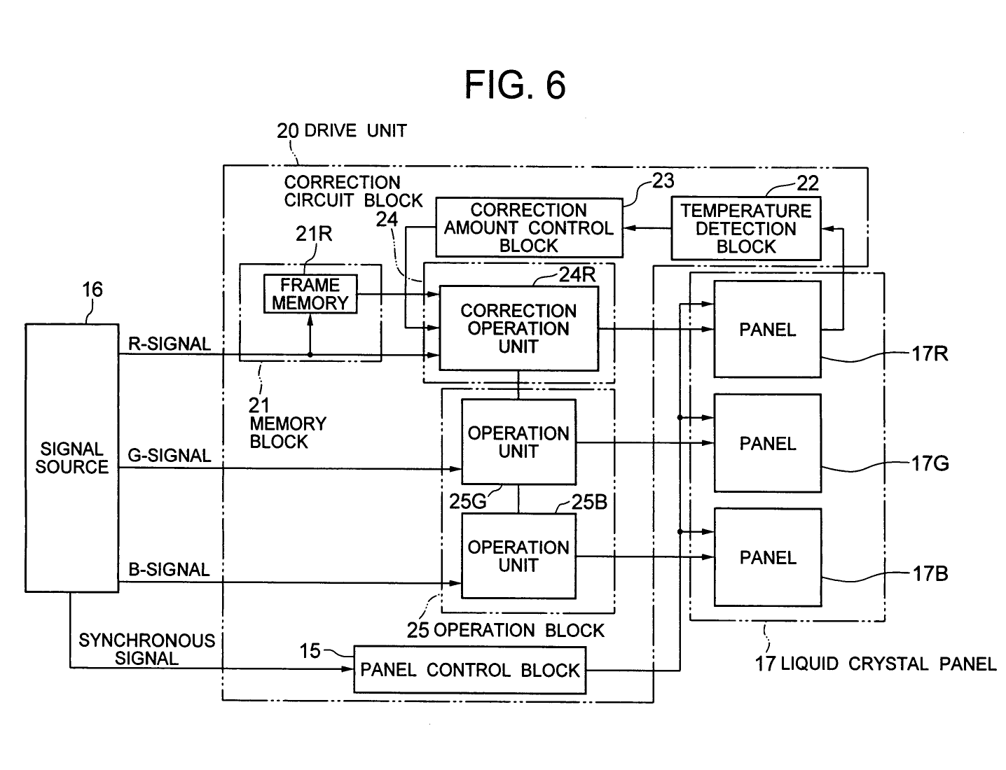

FIG. 6 is a block diagram for showing a second embodiment of the drive unit according to the present invention. Description will be provided hereinafter by referring to the drawing. However, the same reference numerals are applied to the same components as the ones shown in FIG. 4 and the description will be omitted.

A drive unit 20 of the embodiment is an electronic circuit, comprising a memory block 21, a temperature detection block 22, a correction amount control block 23, a correction circuit block 24, an operation block 25, a panel control block 15 and the like. This is used in a three-plate-type liquid crystal projector.

The memory block 21 holds only the video signal of R-color supplied from the signal source 16 at least for one frame period.

The temperature detection block 22 detects the temperature of only the liquid crystal panel 17R or that of the peripheries. The correction amount control block 23 controls the correction amount applied to the video signals. The correction circuit block 24 applies the correction operation to the video signals supplied to the liquid crystal panel 17R according to the previous frame video signal held in the memory block 21R, the present frame video signal, and the input value (correction amount) from the correction amount control block 23. The operation block 25 applies the arithmetic operation other than the overdrive correction to the video signal to be supplied to the liquid crystal panels 17G, 17B according to the present frame video signal. The panel control block 15 controls the liquid crystal panel 17.

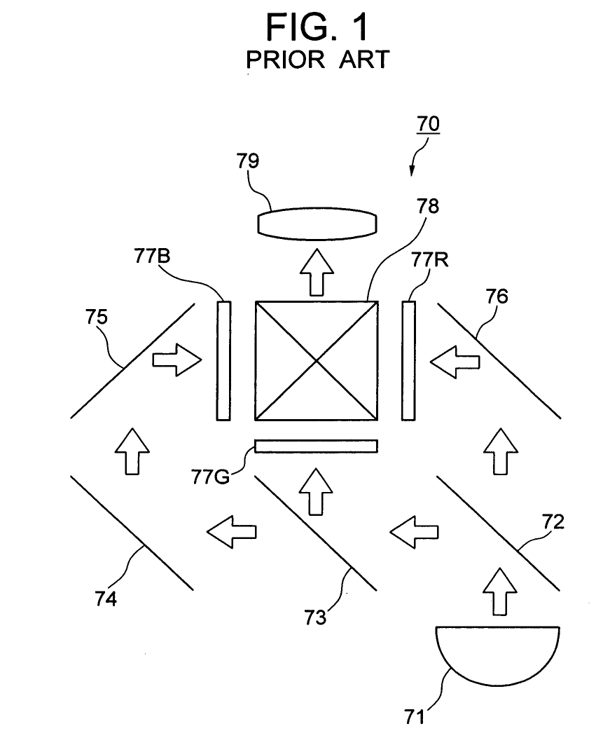

The memory block 21 according to the embodiment is constituted only of the frame memory 21R and temporarily holds only the R-color video signal, which is different from the embodiment shown in FIG. 1. Further, the correction circuit block 24 according to the embodiment is constituted only of the correction operation unit 24R for performing the overdrive correction only on the R-color video signal. Other configurations are the same as those of the first embodiment.

In the embodiment, the configuration is simplified through detecting temperature of only the liquid crystal panel 17R and correcting the video signal of the liquid crystal panel 17R including the temperature. In a regular liquid crystal projector, the temperature of the R-color liquid crystal panel 17R is lower than that of the G-color liquid crystal panel 17G and that of the B-color liquid crystal panel 17B.

Thus, in the embodiment, the response speed of the R-color liquid crystal panel 17R is adjusted to meet the response speeds of other liquid crystal panels 17G, 17B of G and B colors by performing the overdrive correction only on the R-color video signal.

Here, a device for detecting the temperatures is formed by the temperature detection block 22. Further, a device for correction is formed by the memory block 21, the correction amount control block 23 and the correction circuit block 24.

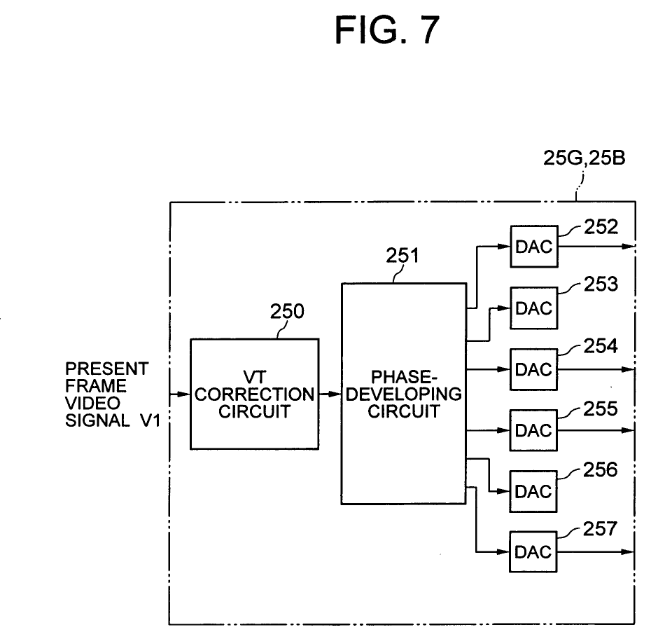

FIG. 7 is a block diagram showing the operation unit included in the operation block 25 shown in FIG. 6.

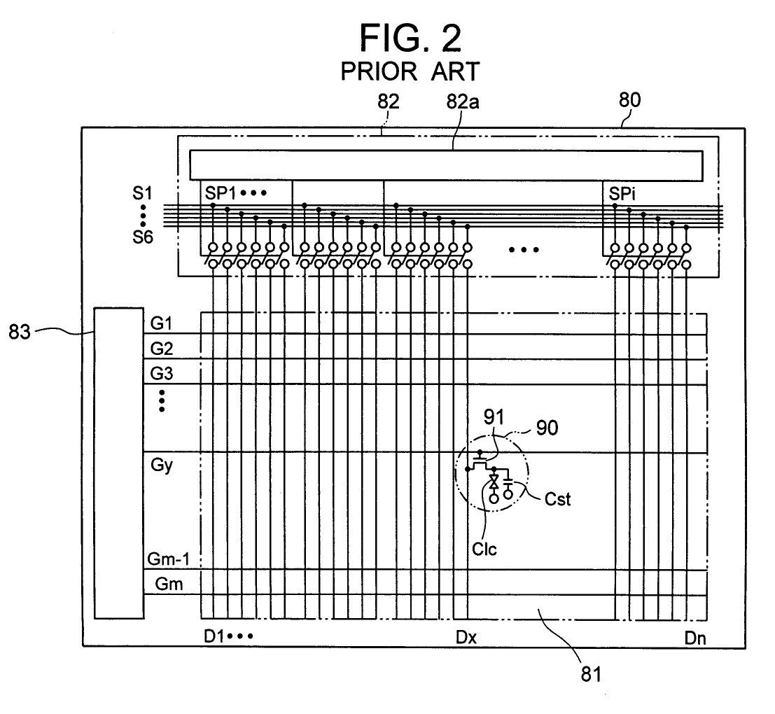

As shown in FIG. 7, the operation units 25G, 25B are constituted of a VT correction circuit 250, a phase developing circuit 251, DACs 252-257 and the like. The one having a configuration shown in FIG. 2 may be used for the correction operation unit 24R.

In the embodiment, the overdrive correction according to the temperature is applied only to the R-color video signal to be displayed on the liquid crystal panel 17R. When there is a large difference between the temperature of the R-color liquid crystal panel 17R and the temperatures of the G-color liquid crystal panel 17G and the B-color liquid crystal panel 17B, the overdrive correction may be applied to the video signal (of G-color or B-color) which is supplied either to the liquid crystal panel 17G or the liquid crystal panel 17B, in addition to performing the overdrive correction to the R-color video signal to be displayed on the liquid crystal panel 17R. The correction operation units 14G, 14B shown in FIG. 4 are used for this overdrive correction. When performing the overdrive correction on the video signals of the colors other than R-color, it is desirable to select the one having the lower temperature from the liquid crystal panels 17G, 17B.

Next, the action of the drive unit 20 will be described. However, most of the action is the same as that of the first embodiment so that only the action of the operation block 25, which is different from the first embodiment, will be described.

The VT correction circuit 250 performs the VT correction on the present frame video signal V1. Then, the phase developing circuit 251 performs phase-development on the VT-corrected video signal V1 for the number of the analog signals to be outputted to the liquid crystal panel 17. At last, the DAC circuits 252-257 convert the phase-developed digital signals to the analog signals and supply them to the liquid crystal panel 17.

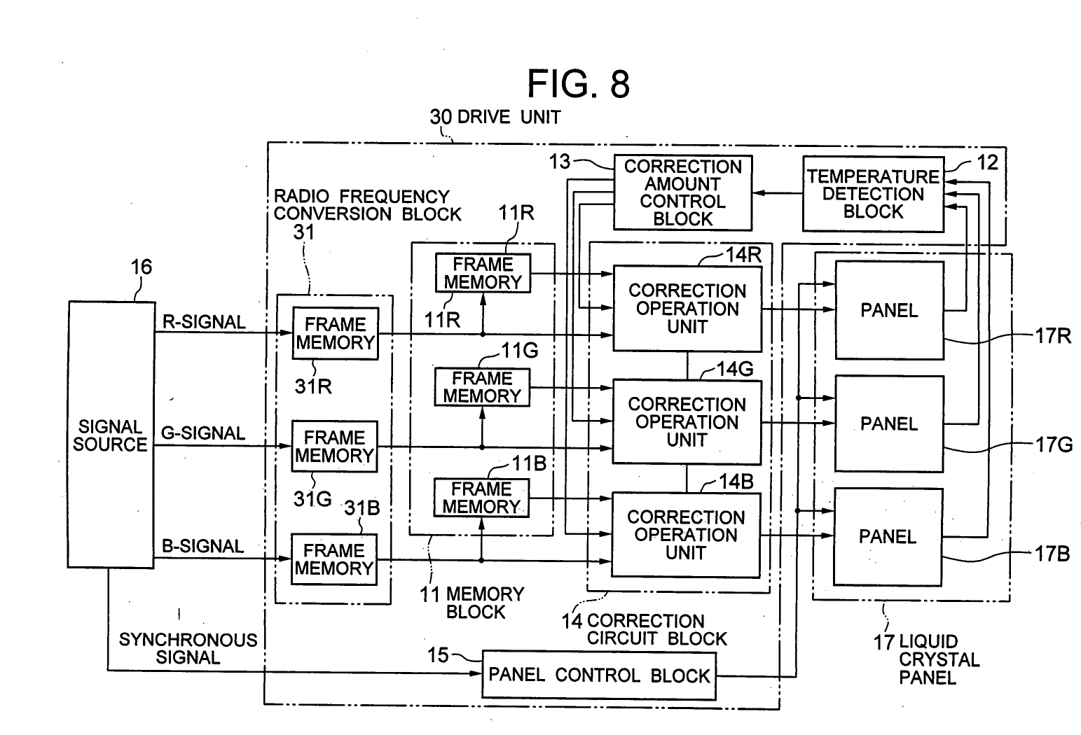

FIG. 8 is a block diagram for showing a third embodiment of the drive unit according to the present invention. Description will be provided hereinafter by referring to the drawing.

A drive unit 30 of the embodiment shown in FIG. 8 is an electronic circuit, comprising a radio-frequency conversion block 31, a memory block 11, a temperature detection block 12, a correction amount control block 13, a correction circuit block 14, a panel control block 15 and the like. This is used in a three-plate-type liquid crystal projector.

The radio-frequency conversion block 31 converts the video signals of each of the colors of R, G, B supplied from the signal source 16 to have the frame radio frequency of at least twice as high or more. The memory block 11 holds the video signals of each of the colors of R, G, B outputted from the radio-frequency conversion block 31 for at least one frame period. The temperature detection block 12 detects the temperature of the liquid crystal panel 17 or that of the peripheries. The correction amount control block 13 controls the correction amount applied to the video signals. The correction circuit block 14 applies the correction operation to the video signals supplied to the liquid crystal panel 17 according to the previous frame video signal held in the memory block 11, the present frame video signal, and the input value (correction amount) from the correction amount control block 13. The panel control block 15 controls the liquid crystal panel 17.

In accordance with the video signals of each of the colors of R, G, B, the radio-frequency conversion block 31 is constituted of frame memories 31R, 31G, 31B, and the memory block 11 is constituted of the frame memories 11R, 11G, 11B. The correction circuit block 14 is constituted of the correction operation units 14R, 14G, 14B, and the liquid crystal panel 17 is constituted of the liquid crystal panels 17R, 17G, 17B.

The configuration within the correction circuit block 14 is the same as the one shown in FIG. 5. The radio-frequency conversion block 31 can be achieved by comprising the frame memories 31R, 31G, 31B capable of holding the video signals of each of the colors of R, G, B for at least two screens.

Next, the action of the drive unit 30 will be described. The video signal supplied from outside is converted to have the frame radio frequency of at least twice the frame radio frequency of the inputted video signal in the radio-frequency conversion block 31 to be outputted. The radio frequency conversion can be achieved by dividing each of the frame memories 31R, 31G, 31B, which can hold each video signal of R, G, B for at least two screens, into two banks and writing the video signal inputted from outside to one of the banks while reading out the video signal held in the other bank at a speed twice or more as fast as that of the synchronous radio frequency of the video signal inputted from outside. The processing thereafter is almost the same as the action of the first embodiment.

A device for detecting the temperatures is formed by the temperature detection block 12. A device for correction is formed by the memory block 21, the correction amount control block 23 and the correction circuit block 24. A device for writing a plurality of times is formed by the radio-frequency conversion block 31, the memory block 21 and the correction circuit block 24.

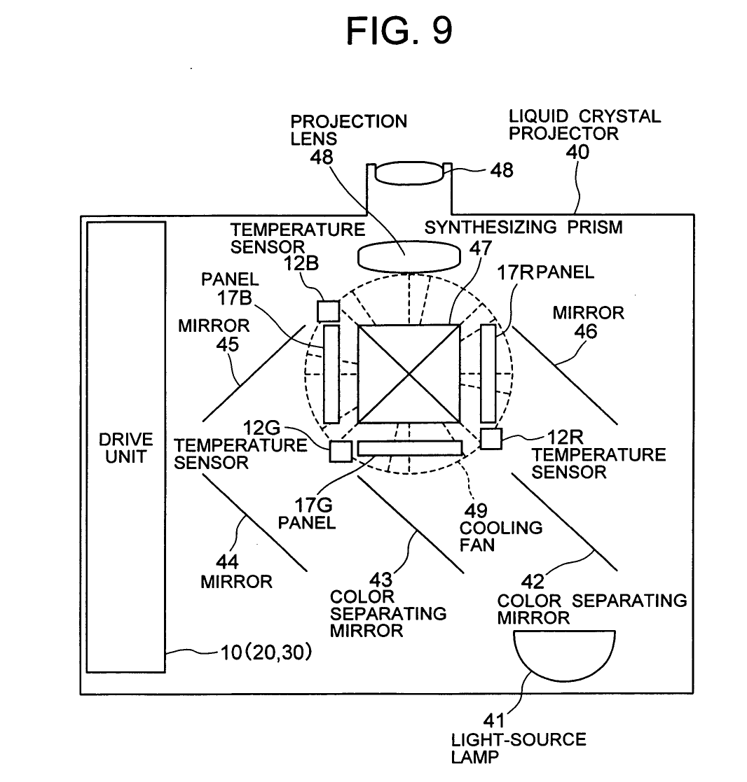

FIG. 9 is a block diagram showing the liquid crystal projector of the present invention which can be driven using the above-described drive units (10, 20, 30) of the present invention. The liquid crystal projector of the present invention shown in FIG. 9 uses the drive unit 10 shown in FIG. 4.

The liquid crystal projector 40 shown in FIG. 9 comprises a drive unit 10, temperature sensors 12R, 12G, 12B, liquid crystal panels 17R, 17G, 17B, a light-source lamp 41, color separating mirrors 42, 43, mirrors 44-46, a synthesizing prism 47, a projection lens 48, a cooling fan 49 and the like. The temperature detection block 12 shown in FIG. 1 includes three temperature sensors 12R, 12G, 12B. The temperature sensor 12R detects the temperature of the R-color liquid crystal panel 12R or the temperature of the peripheries. The temperature sensor 12G detects the temperature of the G-color liquid crystal panel 12G or the temperature of the peripheries. The temperature sensor 12B detects the temperature of the B-color liquid crystal panel 12B or the temperature of the peripheries.

The light emitted from the light-source lamp 41 is separated into each light with the wavelength band of R, G, B through the color separating mirrors 42, 43. The light of R-color is reflected by the mirror 46 and irradiated to the liquid crystal panel 17R. The light of G-color is reflected by the mirror 43 and irradiated to the liquid crystal panel 17G. The light of B-color is reflected by the mirrors 44, 45 and irradiated to the liquid crystal panel 17B. Although not shown, polarization plates are placed in the front and behind the liquid crystal panels 17R, 17G, 17B.

The liquid crystal panels 17R, 17G, 17B to which the light makes an incidence is drive-controlled by the drive unit 10 and a single-color (R, G, B) image is displayed on the liquid crystal panels 17R, 17G, 17B, respectively. The light (video signal) transmitted through each of the liquid crystal panels 17R, 17G, 17B makes an incidence to the synthesizing prism 47. The synthesizing prism 47 synthesizes the single-color video signals transmitted through each of the liquid crystal panels 17R, 17G, 17B and emits the obtained color picture towards the projection lens 48. The projection lens 48 displays the color picture by forming the focal point on the screen (not shown).

Below the synthesizing prism 47, provided are the liquid crystal panels 17R, 17G, 17B, and the cooling fan 49 for cooling the polarization plates. Further, in the vicinity of each of the liquid crystal panels 17R, 17G, 17B, the temperature sensors 12R, 12G, 12B are provided.

The drive unit 10 is constituted of each circuit block shown in FIG. 1, and the output signals of the temperature sensors 12R, 12G, 12B are inputted to the temperature detection block 12. In the embodiment, in each of the liquid crystal panels 17R, 17G, 17B, the temperature sensors 12R, 12G, 12B for detecting the temperature of the peripheries are placed. However, the temperature sensor may be provided to only one or two of the three liquid crystal panels, or may be placed in one area or more within the liquid crystal projector 40. In this case, the correlation between the output signals of the temperature sensor and the temperatures of each liquid crystal panel is actually measured in advance and the relations are held as the data in the correction amount control block 13.

Here, an optical system is formed by the light-source lamp 41, the color separating mirrors 42, 43, the mirrors 44-46, the synthesizing prism 47, and the projection lens 48.

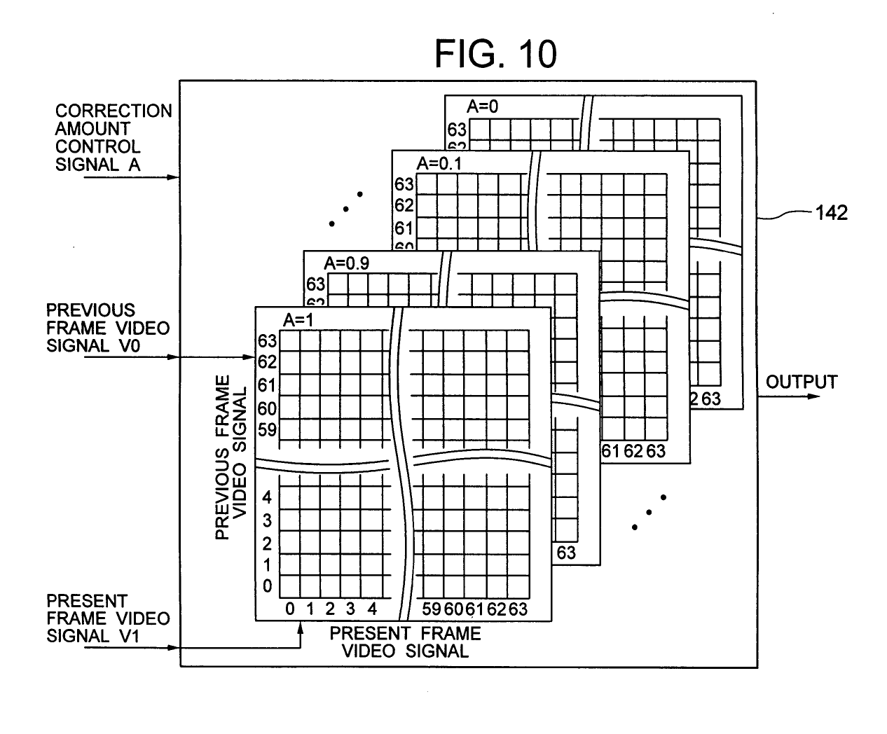

FIG. 10 is an illustration showing an LUT used in the overdrive correction circuit shown in FIG. 5.

As shown in FIG. 10, the LUT used in the overdrive correction circuit 142 is a matrix table, in which the horizontal axis is the present frame video signal as the data of 64 gradations and the vertical axis is the previous frame video signal as the data of 64 gradations. In the matrix table, the voltage data to be actually applied to the liquid crystal panels 17R, 17G, 17b are held by being corresponded to the intersection point of the previous frame video signal and the present frame video signal being shown as the data of 64 gradations. The n-numbers of the tables are provided for each of the liquid crystal panels 17R, 17G, 17B. The “n” corresponds to the number of the phases when performing the phase-development on the video signal by the above-described phase developing circuit. In the embodiment, on the assumption that the correction amount control signal A takes scattering values from 0 to 1, a different table is provided for each value. Further, in each of the tables, both the present frame video signals and the previous frame video signals are the data with 64 gradations. However, it is not limited to this.

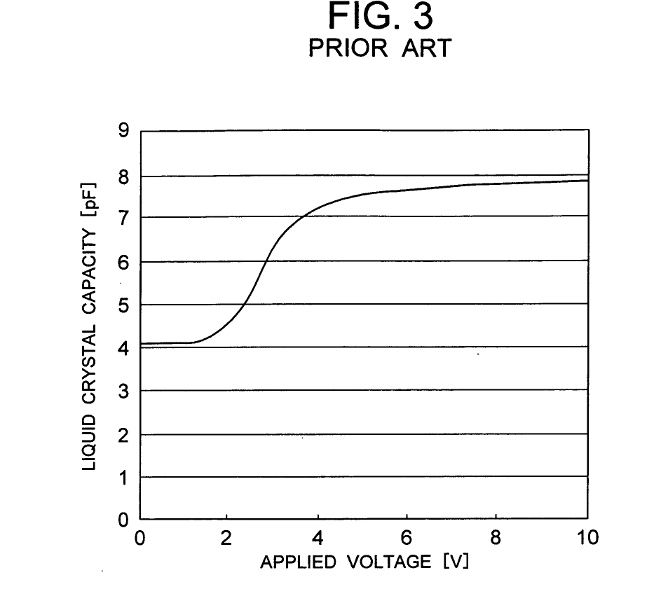

The procedure for forming the table (LUT) will be described. First, for example, by applying the relation of the liquid crystal amount and the applied voltage in the regular state shown in FIG. 3 to the expression (3), the table of the maximum correction amount is formed. Then, the tables corresponding to other correction amounts are obtained by multiplying the difference between the video signal before correction and the video signal with the maximum correction amount by a correction coefficient, and adding the value to the data before correction. Also, it may be formed by measuring the response seed of the liquid crystal panels while experimentally changing the correction amount. The correction amount control block 13 comprises, for example, the tables in which the correction amounts for each temperature of the liquid crystal panels 17R, 17G, 17B are written. Based on the tables, the correction amounts corresponding to the actual temperatures of the liquid crystal panels 17R, 17G, 17B detected by the temperature detection block 12 are calculated. The table can be formed by actually measuring the temperatures of the liquid crystal panels 17R, 17G, 17B and measuring the response speed of the liquid crystal panels 17R, 17G, 17B at that time.

Next, the action will be described. First, the temperatures of the liquid crystal panels 17R, 17G, 17B are regularly detected by the temperature detection block 12. The correction amounts applied to the video signals of each of the liquid crystal panels 17R, 17G, 17B are determined by the correction amount control block 13 based on the result of detection.

In the meantime, the video signal to be displayed in the present frame which is supplied from the signal source 16 is supplied to the correction circuit block 14 and the memory block 11. The memory block 11 reads out the previous frame video signal from the frame memories 11R, 11G, 11B for supplying it to the correction circuit block 14 before writing the present frame video signal to the frame memories 11R, 11G, 11B. In the correction circuit block 14, the present frame video signal and the previous frame video signal are VT-corrected, respectively, and the signals and the correction amount control signal are supplied to the overdrive correction circuit 142. In the overdrive correction circuit 142, one table out of the LUTs is selected according to the correction amount control signal, and the voltage to be actually applied to the liquid crystal panel 17 is determined using the table. Subsequently, the phase-development and DAC is performed on the video signals to be supplied to the liquid crystal panel 17.

In this driving method, different overdrive correction is performed on each of the liquid crystal panels 17R, 17G, 17B so that there is no difference generated in the response speeds of the liquid crystal molecules even when there is a difference in the temperatures of the liquid crystal panes 17R, 17G, 17B. Thus, there is no such phenomenon of “blur tails” being generated at the time of displaying a moving picture. Further, in the configuration of the embodiment, the correction operation is performed by the LUT so that the action can be carried out at a high speed. Thus, it can be easily applied to the liquid crystal panel with high resolution.

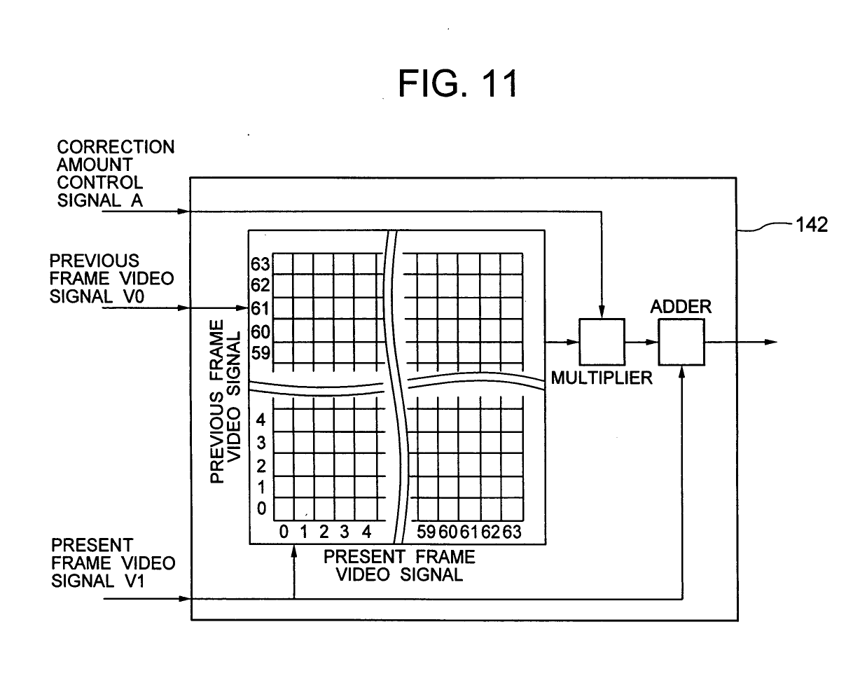

FIG. 11 is a block diagram for showing a second example of the overdrive correction circuit of FIG. 5.

In the embodiment, there is only one LUT for correction being provided to each of the liquid crystal panels 17R, 17G, 17B. Instead, provided is a circuit in which the output of the LUT is multiplied by the correction amount control signal A and the present frame video signal is added to the value. With this LUT, the correction processing can be achieved by the above-described method through recording a differential signal dV which is the difference between the signal corrected by the amount calculated, for example, by the expression (3) and the signal without correction. When the expression (4) is used to obtain the values for being recorded to the LUT, the arithmetic operation result V1′ shown earlier is the value expressed by the expression (5). As a result, the correction amount becomes the maximum when the correction amount control signal A is 1, and there is no correction performed when the signal A is 0.
dV={(Clc(v1)+Cst)/(Clc(V0)+Cst)−1}V1 (4)
V1′=A{(Clc(v1)+Cst)/(Clc(V0)+Cst)−1}V1+V1 (5)

In this driving method, different overdrive correction is performed on each of the liquid crystal panels 17R, 17G, 17B so that there is no difference generated in the response speeds of the liquid crystal molecules even when there is a difference in the temperatures of the liquid crystal panes 17R, 17G, 17B. Thus, there is no such phenomenon of “blur tails” being generated at the time of displaying a moving picture. Further, with the method, it is possible to reduce recording amount required for the LUT so that the scale of the circuit can be minimized. Thus, the correction amount control can be more strictly achieved so that the control of the response speed can be achieved with high precision.

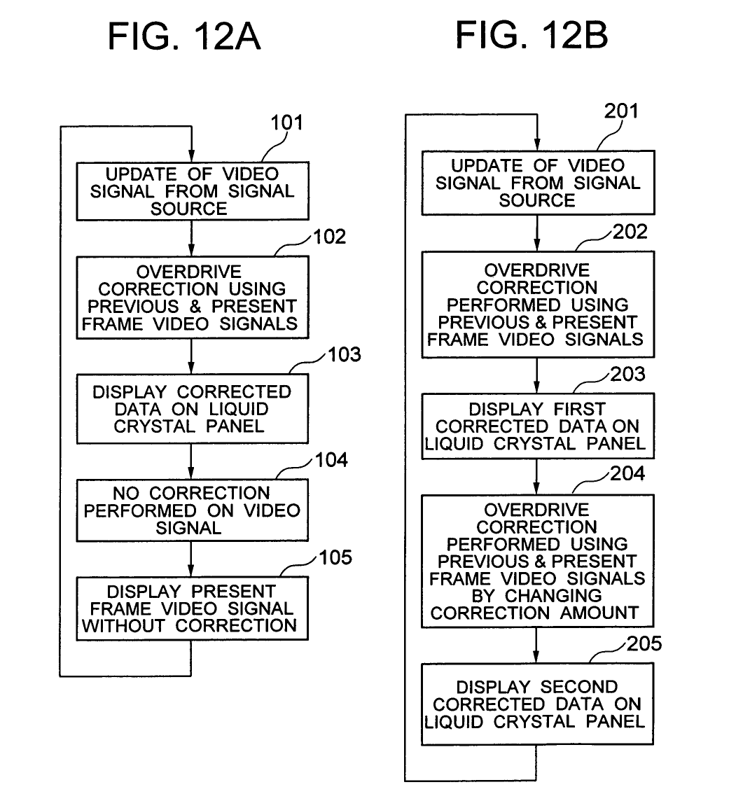

FIG. 12A is a flowchart for showing a first example of the action of the drive unit shown in FIG. 8.

The liquid crystal projector used in the embodiment has the same configuration as that of the one shown in FIG. 9 so that the configuration of the drive unit 30 may be the same as the one shown in FIG. 8. The embodiment has been described by referring to the case where the liquid crystal panel 17 is displayed twice in one frame period by which the video signal for one screen is transmitted from the signal source 16.

First, when the video signal from the signal source 16 is updated (step 101), correction is performed by the method described in the first embodiment or the second embodiment with the updated video signal being the present frame video signal and the video signal supplied previously from the signal source 16 being the previous frame video signal (step 102), and a first display action is performed (step 103). For the second display action, the present frame video signal, instead of the previous frame video signal, is supplied to the correction circuit block 14. As a result, the display action is performed without performing the correction processing (steps 104, 105).

In the driving method, the number of supplying the electric charge to the liquid crystal pixel within a unit time is increased. Therefore, the voltage fluctuation in accordance with the changes in the arrangement of the liquid crystal molecules can be more decreased and effect of improving the response speed can be increased.

FIG. 12B is a flowchart for showing a second example of the action of the drive unit shown in FIG. 8.

The embodiment has been described by referring to the case where the liquid crystal panel 17 is displayed twice in one frame period by which the video signal for one screen is transmitted from the signal source 16.

First, when the video signal from the signal source 16 is updated (step 201), correction is performed by the method described in the first embodiment or the second embodiment with the updated video signal being the present frame video signal and the video signal supplied previously from the signal source 16 being the previous frame video signal (step 202), and a first display action is performed (step 203). In the second display action, the correction processing is also performed based on the previous frame video signal and the present frame video signal but by the correction amount different from that of the first time (steps 204, 205). This correction can be easily achieved by separately providing an LUT for the second correction processing.

In the driving method, the number of supplying the electric charge to the liquid crystal pixel within a unit time is increased. Therefore, the voltage fluctuation in accordance with the changes in the arrangement of the liquid crystal molecules can be more decreased and effect of improving the response speed can be increased. In addition to this effect, the response speed can be more improved by applying the correction of a larger amount than that obtained by the expression (3) in the first processing for further increasing the voltage fluctuation of the liquid crystal pixel, and additionally performing a correction for having it converged in the second processing. The reason for this is that the larger the voltage is, the faster the response speed of the liquid crystal molecule becomes.

1. A drive unit of a liquid crystal panel, comprising
a plurality of liquid crystal panels for respectively displaying an image based on a single-color video signal;
a temperature detection device for measuring temperatures of the liquid crystal panels directly or indirectly; and
a correction device for controlling a correction amount of overdrive correction performed on the video signal according to a measurement of the temperature performed by the temperature detection device, wherein
the correction device performs the overdrive correction with the video signal being a unit.

2. The drive unit of a liquid crystal panel according to claim 1, wherein the correction device performs the overdrive correction respectively on a plurality of video signals which are supplied to a plurality of the liquid crystal panels.

3. The drive unit of a liquid crystal panel according to claim 1, wherein the correction device performs the overdrive correction on the video signal to be supplied to a liquid crystal panel which is in a temperature largely different from that of other liquid crystal panels.

4. The drive unit of a liquid crystal panel according to claim 3, wherein the video signal is a red signal when colors of the video signal are three primary colors.

5. The drive unit of a liquid crystal panel according to claim 1, wherein the correction device performs the overdrive correction on a video signal of a next frame according to three variables, the variables being a data of a video signal displayed on a previous frame of a liquid crystal panel, a data of a video signal displayed on the next frame, and a control value of a correction amount being determined according to the temperature detected by the temperature detection device.

6. The drive unit of a liquid crystal panel according to claim 5, comprising a memory for holding the video signal for one frame, wherein:
the correction device comprises a lookup table having corrected video signal of a present frame recorded in a position which is determined according to two address values, one of which is a digitized video signal of the previous frame held by the memory and the other is a digitized video signal of the present frame; and
the lookup tables are provided in a number which corresponds to a number of resolutions of a signal whose correction amount is to be controlled.

7. The drive unit of a liquid crystal panel according to claim 1, comprising of:
A unit for converting inputted video signals into video signals of twice or more frequency, and outputting the converted video signals.

8. A liquid crystal projector comprising:
a plurality of liquid crystal panels for respectively displaying an image based on a single-color video signal;
a light synthesizing device for synthesizing images displayed on a plurality of the liquid crystal panels into a single picture;
a temperature detection device for measuring temperatures of the liquid crystal panels directly or indirectly; and
a correction device for controlling a correction amount of overdrive correction performed on the video signal according to a measurement of the temperature performed by the temperature detection device, wherein
the correction device performs the overdrive-correction with the video signal being a unit.

9. A driving method of a liquid crystal panel, comprising the steps of:
a measuring step of directly or indirectly measuring, by a temperature detection device, temperatures of a plurality of liquid crystal panels which display images based on a single-color video signal; and
a correction step of controlling a correction amount of an overdrive correction performed on the video signal with the video signal being a unit according to the temperatures measured by the temperature detection device.

10. The driving method of a liquid crystal panel according to claim 9, wherein the overdrive correction is separately performed on all the video signals.

11. The driving method of a liquid crystal panel according to claim 9, wherein the overdrive correction is performed on the video signal which is supplied to a liquid crystal panel which is in a temperature largely different from that of other liquid crystal panels.

12. The driving method of a liquid crystal panel according to claim 11, wherein the video signal is a red signal when colors of the video signal are three primary colors.

13. The driving method of a liquid crystal panel according to claim 11, wherein the overdrive correction is performed on a video signal of a next frame according to three variables, the variables being a data of a video signal displayed on a previous frame of a liquid crystal panel, a data of a video signal displayed on the next frame, and a control value of a correction amount being determined according to the temperature detected by the temperature detection device.

14. The driving method of a liquid crystal panel according to claim 9, wherein:
a video signal for one frame is held in a memory;
a lookup table is formed, having corrected video signal of a present frame recorded in a position which is determined according to two address values, one of which is a digitized video signal of a previous frame held by the memory and the other is a digitized video signal of the present frame;
the lookup tables are provided in a number which corresponds to a number of resolutions of a correction amount control signal; and
a plurality of the lookup tables used for correction are switched when changing the correction amount.

15. The driving method of a liquid crystal panel according to claim 9 which comprises driving the liquid crystal panel to display video signals for one screen twice or more within a frame period in which video signals for one screen supplied.

16. The driving method of a liquid crystal panel according to claim 9 which comprises driving the liquid crystal panel to display video signals for one screen twice or more within a frame period in which video signals for one screen supplied, and making different correction amounts by each drive of the liquid crystal panel.
